(19) United States
(12) Patent Application Publication
(10) Pub. No.: US 2025/0252663 A1
(43) Pub. Date: Aug. 7, 2025

(54) SIGNAL PROCESSING DEVICE, SIGNAL PROCESSING METHOD, AND DATA PRODUCTION METHOD

(71) Applicant: SONY SEMICONDUCTOR SOLUTIONS CORPORATION, KANAGAWA (JP)

(72) Inventors: TATSUJI ASHITANI, KANAGAWA (JP); TAKAYA KITAMURA, KANAGAWA (JP)

(21) Appl. No.: 18/856,737

(22) PCT Filed: Apr. 11, 2023
(86) PCT No.: PCT/JP2023/014725

§ 371 Date: Oct. 14, 2024

(30) Foreign Application Priority Data
Apr. 21, 2022 (JP) 2022-070123

(51) Int. Cl. G06T 17/00

(52) U.S. Cl. CPC G06T 17/00

(57) ABSTRACT

A signal processing device according to the present technology includes a frequency data generation section that generates frequency data that is data indicating a frequency of a point in at least a depth direction, on the basis of three-dimensional point cloud data acquired through three-dimensional measurement of a target space, and a data reduction section that executes data reduction processing for the three-dimensional point cloud data on the basis of the frequency data generated by the frequency data generation section.

### TECHNICAL FIELD

The present technology relates to a signal processing device, a method therefor, and a data production method and particularly relates to a technology for reducing processing load of control processing in a case in which control based on three-dimensional point cloud data regarding a target space is executed as control based on sensing data regarding the target space.

### BACKGROUND ART

For example, there have been known devices such as an AGV (Automatic Guided Vehicle) and an AMR (Autonomous Mobile Robot) which can perform unaided travel.

For control of the unaided travel, it is desired to be capable of acquiring 3D data (three-dimensional point cloud data) as sensing data regarding a target space. The acquisition of the 3D data enables an increase in recognition accuracy of an obstacle and an increase in object recognition capability such as capability of recognizing the height of an object, for example, and hence, enables an increase in reliability and an increase in versatility (for example, knowing the height of an object enables not only avoidance of the obstacle but also loading the object and the like) of the control.

Note that, as a related conventional technology, PTL 1 can be mentioned. In PTL 1, there is disclosed a technology of reducing a data amount of point cloud data through filtering which uses a grid (30) set in advance in a three-dimensional space.

### CITATION LIST

### Patent Literature

[PTL 1]
Japanese Patent Laid-open No. 2015-197329

### SUMMARY

### Technical Problem

Here, the three-dimensional point cloud data has a large data amount compared with two-dimensional data and the like, and hence, it is desired to reduce the data amount.

However, according to the technology disclosed in PTL 1, the grid is set to a fixed position defined in advance in the three-dimensional space or a position defined in advance through a user operation, and hence, there is the possibility that point cloud data essentially required may also be set to a target of the reduction as a result of the filtering through use of this grid.

The present technology has been made in view of the circumstances described above and has an object of efficiently reducing, in a case in which control based on three-dimensional point cloud data regarding a target space is executed as control based on sensing data regarding the target space, the three-dimensional point cloud data, thereby simultaneously achieving an increase in accuracy of the control and a reduction in processing load.

### Solution to Problem

A signal processing device according to the present technology includes a frequency data generation section that generates frequency data that is data indicating a frequency of a point in at least a depth direction, on the basis of three-dimensional point cloud data acquired through three-dimensional measurement of a target space, and a data reduction section that executes data reduction processing for the three-dimensional point cloud data on the basis of the frequency data generated by the frequency data generation section.

With the configuration described above, for the three-dimensional point cloud data, it is possible to efficiently extract only point cloud data in a region in which the point cloud densely exists in the depth direction, in other words, point cloud data at a depth position at which an object is estimated to exist.

Moreover, a signal processing method according to the present technology is a signal processing method including, by a signal processing device, generating frequency data that is data indicating a frequency of a point in at least a depth direction, on the basis of three-dimensional point cloud data acquired through three-dimensional measurement of a target space, and executing data reduction processing for the three-dimensional point cloud data on the basis of the frequency data.

Also with such a signal processing method, there can be obtained workings similar to those of the signal processing device according to the present technology described above.

In addition, a data production method according to the present technology is a data production method for producing control data to be used in a control system that executes control based on three-dimensional point cloud data acquired through three-dimensional measurement of a target space, in which the control data includes the three-dimensional point cloud data and frequency data that is generated on the basis of the three-dimensional point cloud data and that indicates a frequency of a point in at least a depth direction, and the control data used when the control system executes data reduction processing for the three-dimensional point cloud data on the basis of the frequency data is produced.

With the control data produced through such a data production method, it is possible to efficiently reduce three-dimensional point cloud data other than point cloud data existing at a depth position at which an object is estimated to exist, in a case in which the control based on the three-dimensional point cloud data regarding the target space is executed.

### BRIEF DESCRIPTION OF DRAWINGS

FIG. 1 is a block diagram for illustrating a configuration example of a signal processing device as a first embodiment according to the present technology.

FIG. 2 is a view for illustrating an example of a target space of three-dimensional measurement and a use form example of the signal processing device according to the embodiment.

FIG. 3 is an explanatory diagram of three-dimensional point cloud data.

FIG. 4 is a plan view of the three-dimensional point cloud data as viewed from above an X-Z plane.

FIG. 5 is an explanatory diagram of a frequency data generation method as a first example.

FIG. 6 is a graph for visualizing and illustrating an example of frequency data.

FIG. 7 is an explanatory diagram of a frequency data generation method as a second example.

FIG. 8 is a graph for schematically illustrating an example of a frequency of a point in a Z direction obtained for each line.

FIG. 9 is a flowchart for illustrating a processing procedure example of signal processing as the first embodiment.

FIG. 10 is a block diagram for illustrating a configuration example of a signal processing device as another example in the first embodiment.

FIG. 11 is an explanatory diagram of a three-dimensional measurement method as a second embodiment.

FIG. 12 is a plan view of three-dimensional point cloud data as viewed from above the X-Z plane for each measurement section in the second embodiment.

FIG. 13 is a block diagram for illustrating a configuration example of a signal processing device as the second embodiment.

FIG. 14 is a flowchart for illustrating a processing procedure example of signal processing as the second embodiment.

FIG. 15 is a block diagram for illustrating a configuration example of a signal processing device as a third embodiment.

FIG. 16 is an explanatory diagram of data structure examples of the three-dimensional point cloud data and the frequency data to be transferred.

FIG. 17 is a block diagram for illustrating a configuration example of a signal processing device as another example in the third embodiment.

FIG. 18 is a block diagram for illustrating a configuration example of a control system according to the present technology.

### DESCRIPTION OF EMBODIMENTS

With reference to the accompanying drawings, embodiments according to the present technology are described in the following order.
<1. First Embodiment>
(1-1. Configuration of Signal Processing Device)
(1-2. Regarding Frequency Data Generation)
(1-3. Regarding Data Reduction Processing)
(1-4. Processing Procedure)
(1-5. Regarding Other Configuration Examples)
<2. Second Embodiment>
<3. Third Embodiment>
<4. Modification Examples>
<5. Summary of Embodiments>
<6. Present Technology>

### 1. First Embodiment

### 1-1. Configuration of Signal Processing Device

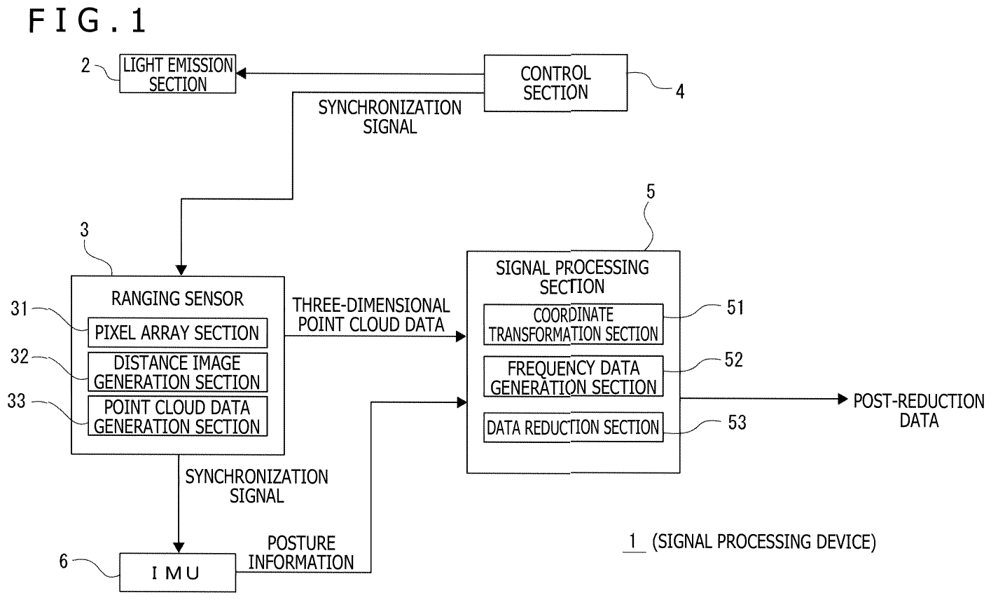

FIG. 1 is a block diagram for illustrating a configuration example of a signal processing device 1 as a first embodiment of the present technology.

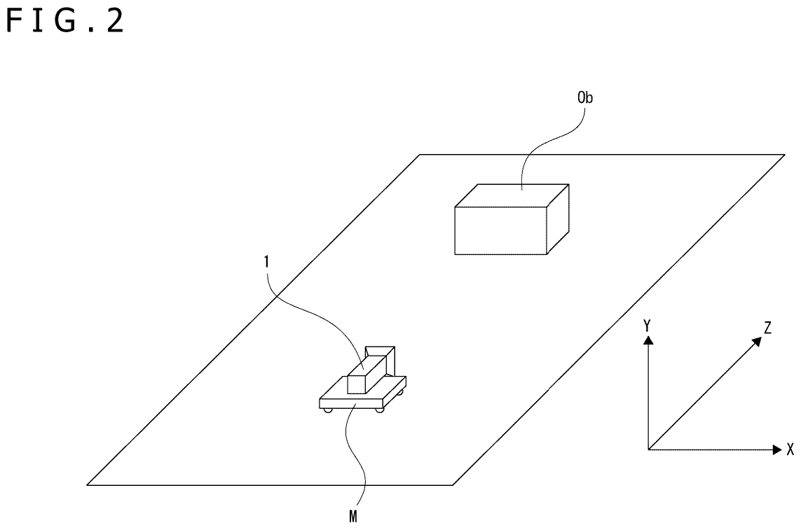

The signal processing device 1 is configured as a three-dimensional survey device having a function of executing three-dimensional measurement of a target space to generate three-dimensional point cloud data. In the example mentioned here, the signal processing device 1 is used in a state of being mounted on a moving body M as exemplified in FIG. 2. In this example, the moving body M is assumed to be a moving body of a ground contact type which drives a driven body, for example, wheels, in contact with a ground or a floor surface, to be able to travel on the ground or the floor surface. Moreover, the moving body M is assumed to be configured as a device which can perform unaided travel such as an AGV (Automated Guided Vehicle) or an AMR (Autonomous Mobile Robot), and to be able to execute control for the unaided travel on the basis of the three-dimensional point cloud data acquired as a result of the three-dimensional measurement by the signal processing device 1. This control for the unaided travel includes control of avoiding collision with an object Ob in the target space.

Moreover, in this example, the three-dimensional measurement of the target space by the signal processing device 1 is executed by use of a ranging sensor that measures a distance to an object. Specifically, in this example, a case in which the ToF (Time of Flight) method is employed as the ranging method is exemplified. As publicly known, the ToF method is a method in which reflected light of light applied to an object is received by a ranging sensor and the ranging is executed on the basis of information regarding time from the application of light to the reception of light (information regarding flight time of light).

As the ToF method, the dToF (direct ToF) method and the iToF (indirect ToF) method are known.

As illustrated in FIG. 1, the signal processing device 1 includes a light emission section 2, a ranging sensor 3, a control section 4, a signal processing section 5, and an IMU (Inertial Measurement Unit) 6.

The light emission section 2 emits light for the ranging through the ToF method. For example, the light emission section 2 emits light in a predetermined wavelength band such as infrared light.

The light emitted from the light emission section 2 is applied to a space (target space) that is the target of the three-dimensional measurement, via an application optical system including a lens and the like, which is omitted from the illustration.

In the case of the ToF method, the light emission section 2 executes pulse light emission at a predetermined cycle. Light emission of the light emission section 2 is controlled by the control section 4.

The control section 4 includes at least a light emission control circuit for the light emission section 2, executes light emission control for causing the light emission section 2 to emit light in a predetermined light emission form (light emission control for causing the light emission section 2 to execute the pulse light emission in this example where the ToF method is employed), and outputs a synchronization signal synchronized with the light emission cycle of the light emission section 2 to the ranging sensor 3.

The ranging sensor 3 includes a pixel array section 31, a distance image generation section 32, and a point cloud data generation section 33.

The pixel array section 31 includes pixels each of which has a light reception element and which are two-dimensionally arranged. The reflected light obtained by the light emitted from the light emission section 2 being reflected on the object is made incident on the pixel array section 31 via a light reception optical system including a lens and the like, which is omitted from the illustration.

To the ranging sensor 3, the synchronization signal described above is input from the control section 4, and the pixel array section 31 executes a light reception operation at a cycle synchronized with this synchronization signal.

The distance image generation section 32 executes a predetermined arithmetic operation for the distance calculation through the ToF method on the basis of light reception signals for the respective pixels obtained by the pixel array section 31 executing the light reception operation corresponding to the ToF method, to thereby generate a distance image. The distance image herein means an image indicating information regarding the distance to the subject for each pixel.

The point cloud data generation section 33 generates three-dimensional point cloud data representing a three-dimensional structure of the target space, on the basis of the distance image generated by the distance image generation section 32.

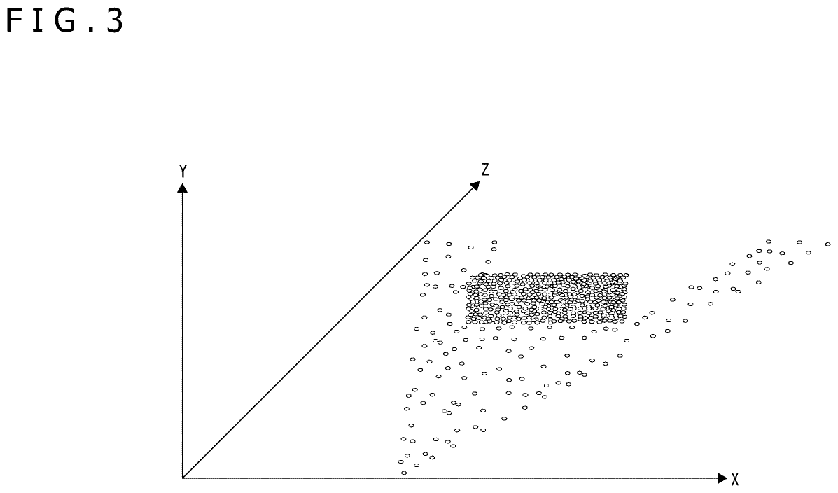

FIG. 3 is an explanatory diagram of the three-dimensional point cloud data and schematically illustrates the three-dimensional point cloud data obtained in the case in which the three-dimensional measurement is executed in such an environment in which the object Ob exists in front of the device as illustrated in FIG. 2.

The three-dimensional point cloud data is data which indicates coordinates of each measured point in a world coordinate system defined for the target space. The world coordinate system herein specifically is a coordinate system having a Z axis in a depth direction, an X axis in a lateral direction (a direction parallel with a horizontal plane and orthogonal to the Z axis), and a Y axis in a vertical direction (a direction orthogonal to the Z axis and the X axis), and the three-dimensional point cloud data is data indicating (X, Y, Z) coordinates of each point.

As illustrated, the three-dimensional point cloud data acquired for the environment of FIG. 2 has such a tendency that the point cloud is concentrated in the Y direction on a front surface (a surface facing the signal processing device 1) of the object Ob and is sparce on a floor surface on which the object Ob is placed. Moreover, in this example, the ranging for acquiring the three-dimensional point cloud data is executed by receiving the reflected light of the light applied to the object Ob side by the light emission section 2 as described before, and hence, a range in which the point cloud data is obtained is limited to at least a range which the light applied by the light emission section 2 reaches. Moreover, the light does not reach a part rearward of the front surface in the object Ob or an amount of light which reaches the rear part is extremely small, and hence, point cloud is hardly acquired on the part rearward of the front surface in this object Ob.

Here, the distance image obtained by the distance image generation section 32 has the position of each pixel represented in a (u, v) coordinate system having, as a u direction, a horizontal line direction in the pixel array section 31 and, as a v direction, a direction orthogonal to the horizontal line direction. Thus, a distance z calculated for each pixel can be expressed as coordinates of (u, v, z).

The point cloud data generation section 33 illustrated in FIG. 1 transforms the (u, v, z) coordinates for each pixel of the distance image to the (X, Y, Z) coordinates in the world coordinate system, thereby generating the three-dimensional point cloud data. The coordinate transformation on this occasion can be executed on the basis of optical parameters (camera parameters) such as a focal point distance and the like of the light reception optical system described before.

The three-dimensional point cloud data generated by the point cloud data generation section 33 is output to the signal processing section 5.

The IMU 6 includes motion sensors such as an acceleration sensor and a gyro sensor (angular velocity sensor) and detects, as posture information regarding the signal processing device 1, information indicating inclination in each of a yaw direction, a pitch direction, and a roll direction of the signal processing device 1.

As illustrated, to the IMU 6, the synchronization signal, specifically, the synchronization signal synchronized with the frame cycle of the pixel array section 31, is input from the ranging sensor 3, and the IMU 6 detects the posture information at a cycle synchronized with this synchronization signal.

The posture information detected by the IMU 6 is output to the signal processing section 5.

The signal processing section 5 includes a processor such as a microcomputer, an FPGA (Field-Programmable Gate Array), or a DSP (Digital Signal Processor) including a CPU (Central Processing Unit), a ROM (Read Only Memory), a RAM (Random Access Memory), and the like, for example, and performs various types of signal processing on the three-dimensional point cloud data. As illustrated, the signal processing section 5 has functions as a coordinate transformation section 51, a frequency data generation section 52, and a data reduction section 53.

The coordinate transformation section 51 executes the coordinate transformation for the three-dimensional point cloud data input from the ranging sensor 3, on the basis of the posture information input from the IMU 6. The coordinate transformation here is executed to compensate a deviation from an ideal posture for the mounting posture of the signal processing device 1.

For example, in a case in which the mounting posture of the signal processing device 1 deviates from the ideal posture, for example, the signal processing device 1 is mounted in an obliquely inclined posture, data indicating correct coordinates in the assumed world coordinate system cannot be acquired as the three-dimensional point cloud data. Thus, the coordinate transformation processing for the three-dimensional point cloud data is executed such that the posture of the signal processing device 1 detected by the IMU 6 matches the ideal posture, so that the three-dimensional point cloud data indicates the correct coordinates in the world coordinate system.

Note that it is not indispensable to provide the IMU 6 for the coordinate transformation by the coordinate transformation section 51. For example, the ranging operation by the ranging sensor 3 is executed in advance for a predetermined calibration board or the like as a target, and the mounting posture of the signal processing device 1 is detected on the basis of the distance image obtained through this ranging. After that, there may be employed such a method that, on the basis of information regarding the mounting posture detected as described above, the coordinate transformation section 51 executes the coordinate transformation for the three-dimensional point cloud data.

The frequency data generation section 52 generates frequency data (histogram) that is data indicating a frequency of the point in at least the depth direction (that is, the Z direction), on the basis of the three-dimensional point cloud data obtained after the coordinate transformation by the coordinate transformation section 51.

The data reduction section 53 executes data reduction processing for the three-dimensional point cloud data on the basis of the frequency data generated by the frequency data generation section 52.

A description is now given of details of a method for generating the frequency data by the frequency data generation section 52 and the data reduction processing by the data reduction section 53.

### 1-2. Regarding Frequency Data Generation

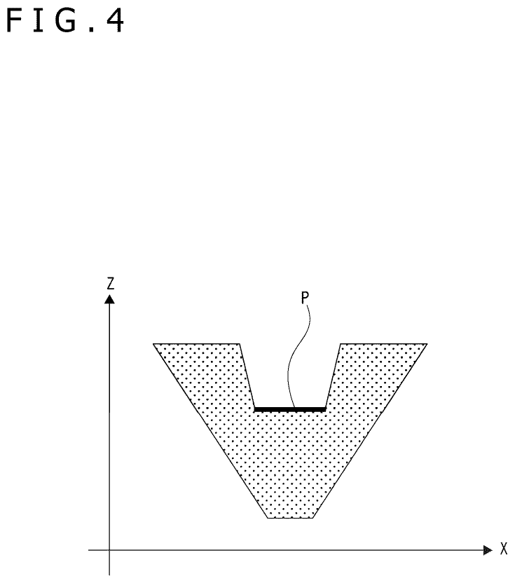

With reference to FIG. 4 to FIG. 8, a description is now given of an example of the method for generating the frequency data by the frequency data generation section 52.

As described before, by generating the frequency data that is the data indicating the frequency of the point in the Z direction for the three-dimensional point cloud data, it is possible to estimate a distribution of a point cloud density in the Z direction. In the case of the three-dimensional point cloud data exemplified in FIG. 3, the density of the point cloud is sparce for a portion of the floor surface in which the object Ob does not exist, in other words, the measured frequency of the point is low for the portion. Meanwhile, for a portion in which the object Ob exists, the density of the point cloud is high, and hence, the measured frequency of the point is high.

Accordingly, when the frequency data as described above is generated and a Z-direction region having the frequency equal to or higher than a threshold value in this frequency data is identified, a region where the object Ob exists in the Z direction (in this example, a region where the front surface portion of the object Ob exists) can be identified.

However, only with the region where the object Ob exists in the Z direction being identified, regions where the object Ob exists in the X direction and the Y direction are unknown, and hence, it is difficult to perform, for example, such travel control that the moving body M is caused to pass while avoiding the region where the object Ob exists. Moreover, also in a case in which control of causing the moving body M to stop before the object Ob to avoid collision with the object Ob is executed, when the regions where the object Ob exists in the X direction and the Y direction are unknown, there is the possibility that the moving body M may unnecessarily be stopped, for example, the moving body M may be stopped even at an X direction position at which the object Ob does not exist.

Accordingly, in this example, as the frequency data, there is generated data which indicates not only the frequency of the point in the Z direction but also the frequency of the point in the orthogonal direction (the X direction or the Y direction) of the Z direction. In this example, specifically, as the frequency data, data indicating the frequencies of the point in two directions, i.e., the Z direction and the X direction, is generated.

FIG. 4 is a top view of the three-dimensional point cloud data illustrated in FIG. 3, as viewed from above the X-Z plane.

A region indicated as “P” in the view, that is, a region where the object Ob exists on the X-Z plane, can be identified by generating the frequency data indicating the frequencies of the point in the two directions, i.e., the Z direction and the X direction, as described above.

As a specific method for generating the frequency data, a description is now given of a first example and a second example.

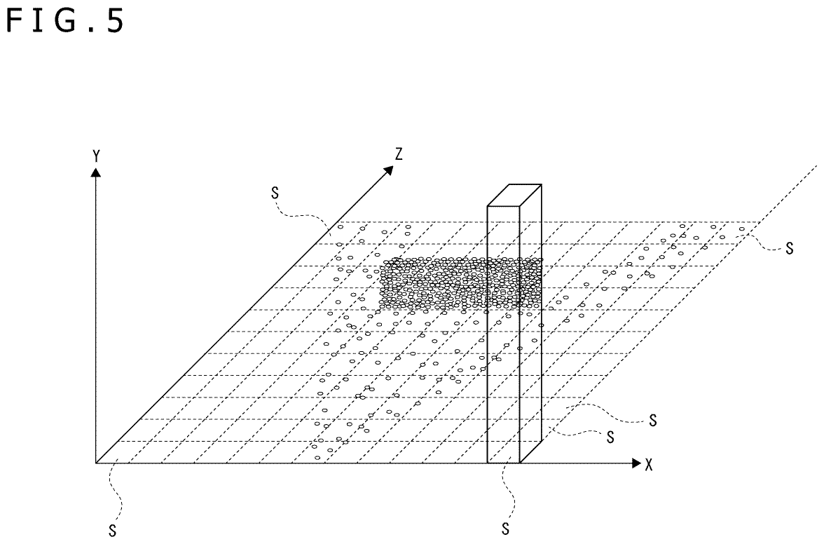

FIG. 5 is an explanatory diagram of the frequency data generation method as the first example.

In the first example, as indicated by dotted-line frames in the diagram, a plurality of cells S obtained by dividing the X-Z plane in a grid form is defined, and the frequency of the point is obtained for each cell S, thereby generating the frequency data indicating the frequencies of the point in the two directions, i.e., the Z direction and the X direction.

Here, the size of each cell S may be a size corresponding to one coordinate unit in the world coordinate system or may be a size corresponding to a plurality of coordinate units.

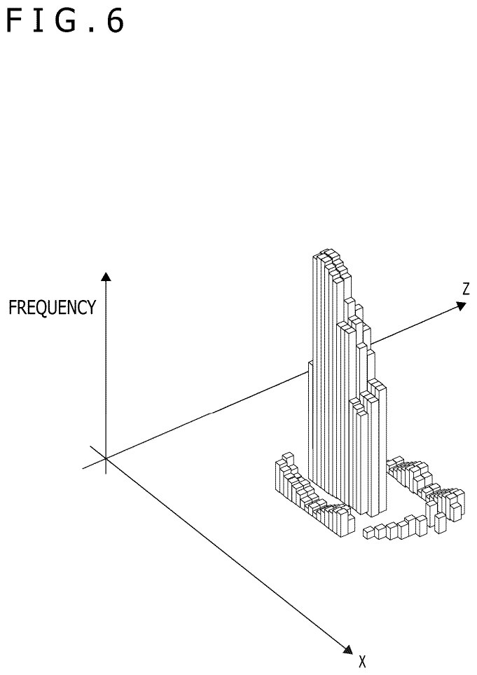

FIG. 6 is a graph for visualizing and illustrating the generated frequency data.

From FIG. 6, it is appreciated that the frequency data in this case presents high frequencies in a region where the front surface portion of the object Ob exists on the X-Z plane.

In the case of the first example, the frequency data generation section 52 obtains the frequency of the point for each cell S through the method described with reference to FIG. 5, on the basis of the three-dimensional point cloud data, thereby generating the frequency data indicating the frequency of the point on the X-Z plane as illustrated in FIG. 6.

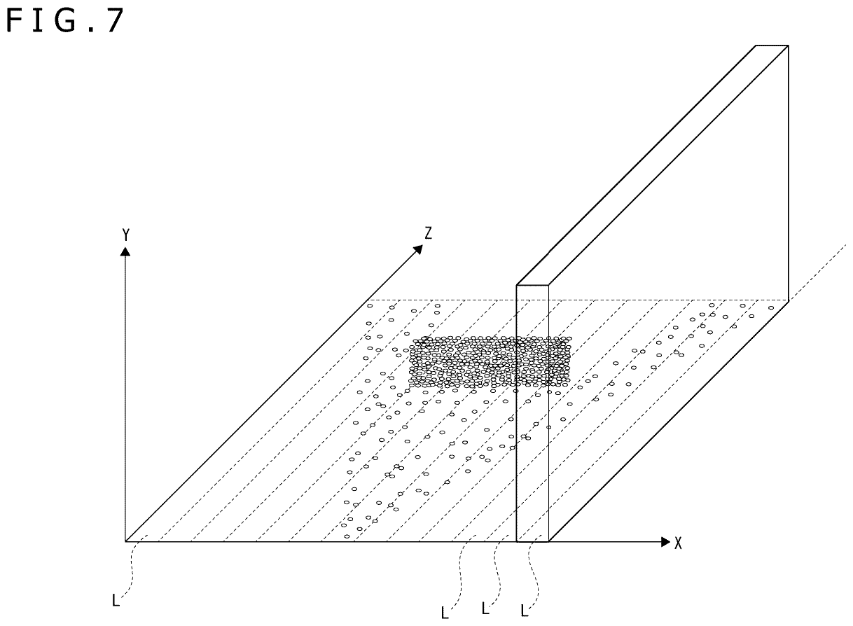

FIG. 7 is an explanatory diagram of the frequency data generation method as the second example.

In the second example, as indicated by dotted lines in the diagram, a plurality of lines L obtained by dividing the X-Z plane in a strip form in the X direction is defined, and the frequency of the point in the Z direction is obtained for each line L, thereby generating the frequency data indicating the frequencies of the point in the two directions, i.e., the Z direction and the X direction.

The width of each line L may be a size corresponding to one coordinate unit in the world coordinate system or may be a size corresponding to a plurality of coordinate units.

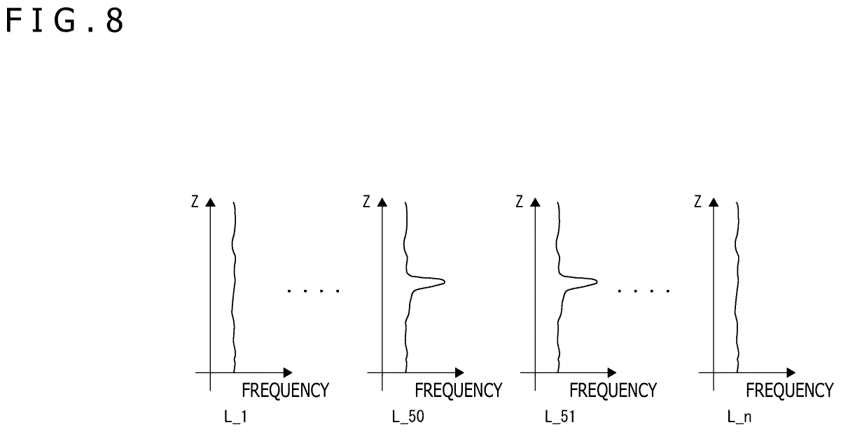

FIG. 8 is a graph for schematically illustrating an example of the frequency of the point in the Z direction obtained for each line L. For example, in a case in which the three-dimensional point cloud data of FIG. 3 is assumed, a change in frequency of the point in the Z direction is small on lines L in vicinities of end portions in the X direction as illustrated (this is because the lines L almost correspond to the floor surface). Meanwhile, on lines L in a center portion in which the object Ob exists, the frequency of the point in the Z direction has such a characteristic that the frequency is high in a certain region in the Z direction as illustrated.

By combining the pieces of data regarding the frequency of the point in the Z direction for the respective lines L, frequency data similar to that illustrated in FIG. 6 is obtained.

### 1-3. Regarding Data Reduction Processing

The data reduction section 53 executes processing for extracting point cloud data that is included in the frequency data generated by the frequency data generation section 52 and that has a frequency equal to or higher than a predetermined threshold value. Specifically, an X-Z region having a frequency equal to or higher than the predetermined threshold value is identified in the frequency data, and point cloud data having coordinates within this X-Z region is extracted.

As a result, it is possible to efficiently extract the point cloud data in the region in which the object Ob is estimated to exist on the X-Z plane.

Here, it is conceivable that the data reduction section 53 outputs, as post-reduction data for the three-dimensional point cloud data to be output to a post stage, the point cloud data extracted as described above without making any change.

As another example, as the post-reduction data, it is also conceivable that data having a data amount further reduced is generated for the point cloud data extracted as described above and is then output.

For example, it is conceivable to generate two-dimensional data obtained by projecting the point cloud data extracted as described above on the two-dimensional plane (X-Z plane) defined by the Z axis and the X axis and to output this two-dimensional data.

As another example, it is conceivable to extract only coordinate information in the Z direction regarding the point cloud data extracted as described above and to output the coordinate information.

### 1-4. Processing Procedure

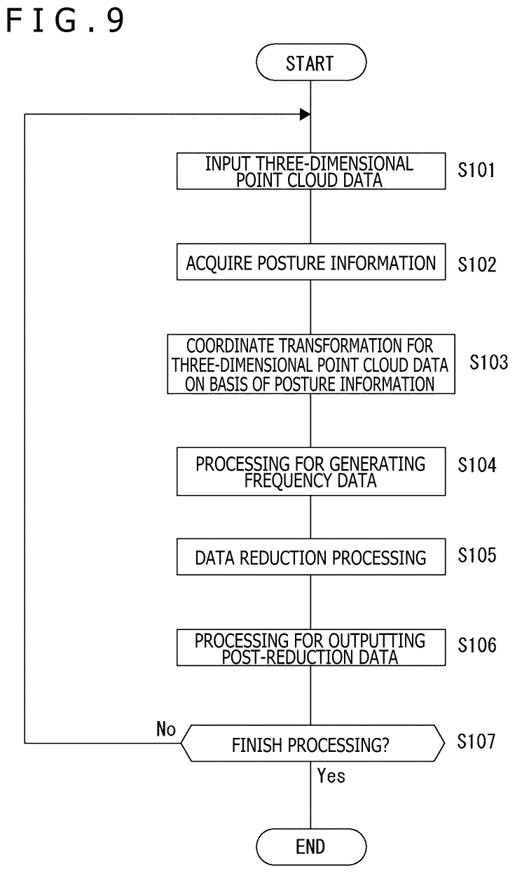

For confirmation, with reference to a flowchart illustrated in FIG. 9, a description is now given of a procedure example of the processing executed by the signal processing section 5 illustrated in FIG. 1.

First, in Step S101, the signal processing section 5 inputs the three-dimensional point cloud data. This processing in Step S101 is processing for inputting the three-dimensional point cloud data acquired by the ranging sensor 3, for each frame period of the distance image.

In Step S102 following Step S101, the signal processing section 5 acquires posture information. That is, the signal processing section 5 acquires the posture information regarding the signal processing device 1 detected by the IMU 6.

In Step S103 following Step S102, the signal processing section 5 executes the coordinate transformation for the three-dimensional point cloud data based on the posture information. This is the processing as the coordinate transformation section 51 described before.

In Step S104 following Step S103, the signal processing section 5 executes the processing for generating the frequency data. That is, the signal processing section 5 executes the processing for generating the frequency data through the method as the first example or the second example described before, on the basis of the three-dimensional point cloud data obtained after the coordinate transformation in Step S103.

In Step S105 following Step S104, the signal processing section 5 executes the data reduction processing. That is, the signal processing section 5 executes the data reduction processing for the three-dimensional point cloud data as described before as the processing by the data reduction section 53, on the basis of the frequency data generated in Step S104, thereby obtaining the post-reduction data.

In Step S106 following Step S105, the signal processing section 5 executes the processing for outputting the post-reduction data.

It is conceivable to output the post-reduction data to, for example, a control device that is mounted to the moving body M and that executes the travel control for the moving body M.

In Step S107 following Step S106, the signal processing section 5 determines whether or not to finish the processing. That is, the signal processing section 5 determines whether or not a predetermined condition defined in advance for finishing the processing for the data reduction of the three-dimensional point cloud data is satisfied.

In a case in which the signal processing section 5 determines not to finish the processing in Step S107, the signal processing section 5 returns to Step S101. That is, in this case, the processing in Steps S101 to S106 is executed for a next frame.

On the other hand, in a case in which the signal processing section 5 determines to finish the processing in step S107, the signal processing section 5 finishes the series of processing illustrated in FIG. 9.

### 1-5. Regarding Other Configuration Examples

Note that, there has been given the example in which the data indicating the frequency of the point in the Z direction or the data indicating the frequencies of the point in the two directions, i.e., the Z direction and the X direction, is generated as the frequency data, but it is also conceivable to generate, as the frequency data, data indicating the frequencies of the point in the three directions of the Z direction, the X direction, and the Y direction.

Moreover, it is also conceivable that whether or not the data reduction for the three-dimensional point cloud data is to be executed is made selectable through a user operation, which is not particularly mentioned in the description given above.

In this case, the signal processing section 5 executes the above-described processing as the coordinate transformation section 51, the frequency data generation section 52, and the data reduction section 53 in a state in which setting to execute the data reduction has been made through the operation, and outputs the post-reduction data. On the other hand, the signal processing section 5 does not execute the processing as at least the frequency data generation section 52 and the data reduction section 53 in a state in which setting not to execute the data reduction has been made through the operation, and outputs not the post-reduction data but the three-dimensional point cloud data.

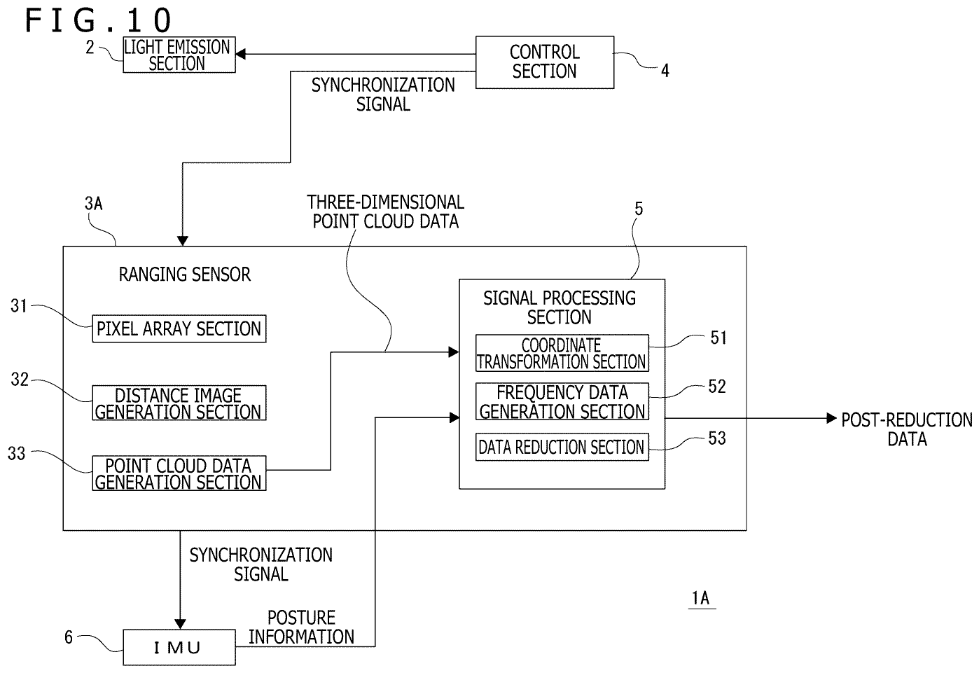

Moreover, in the description given above, there has been given the example in which the signal processing section 5 is provided outside the ranging sensor 3, but, as a signal processing device 1A as another example illustrated in FIG. 10, it is also possible to employ such a configuration that a ranging sensor 3A internally provided with the signal processing section 5 is provided in place of the ranging sensor 3.

### 2. Second Embodiment

A description is now given of a second embodiment. The second embodiment is an embodiment corresponding to a case in which a plurality of measurement sections for executing three-dimensional measurement is provided.

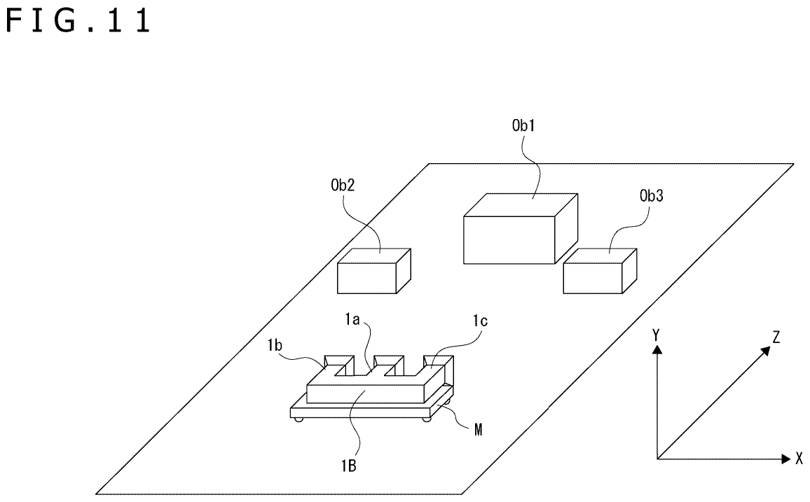

For example, as exemplified in FIG. 11, there is assumed a signal processing device 1B including three measurement sections, i.e., a measurement section 1a, a measurement section 1b, and a measurement section 1c. The “measurement sections” here each refer to a unit section that includes the light emission section 2 and the ranging sensor 3 and that can generate three-dimensional point cloud data, which is also described later.

In this configuration, it is assumed that, in the target space, an object Ob1 is disposed in front of the measurement section 1a disposed at the center as illustrated, an object Ob2 is disposed in front of the measurement section 1b disposed on the left side of the measurement section 1a, and an object Ob3 is disposed in front of the measurement section 1c disposed on the right side of the measurement section 1a.

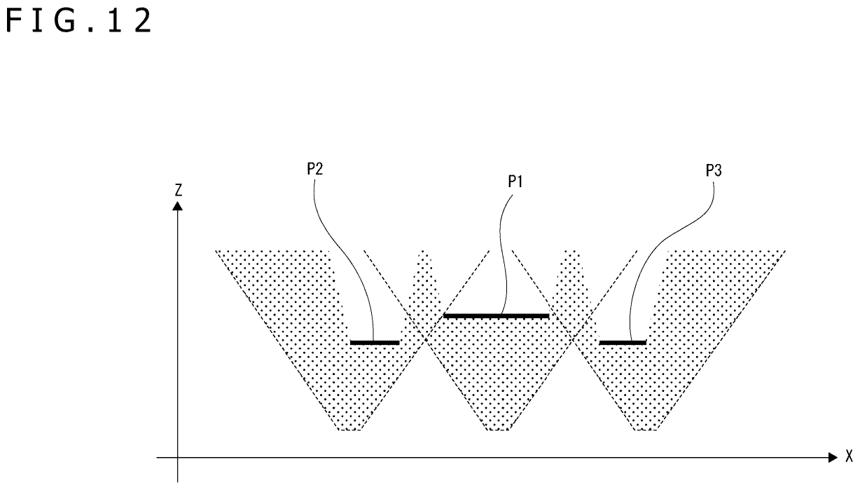

FIG. 12 is a top view of three-dimensional point cloud data acquired by the respective measurement sections 1a, 1b, and 1c, as viewed from above the X-Z plane.

Compared with the top view illustrated in FIG. 4, it is appreciated that the range in which the three-dimensional measurement is possible is increased by providing the plurality of measurement sections.

In a case in which the object disposition of FIG. 11 is assumed, in three-dimensional point cloud data of the measurement section 1a, as denoted as “P1” in the view, a region in which a point cloud is concentrated is observed in a region in which a front surface portion of the object Ob1 exists. Moreover, in three-dimensional point cloud data of the measurement section 1b, as denoted as “P2” in the view, a region in which a point cloud is concentrated is observed in a region in which a front surface portion of the object Ob2 exists, and, in three-dimensional point cloud data of the measurement section 1c, as denoted as “P3” in the view, a region in which a point cloud is concentrated is observed in a region in which a front surface portion of the object Ob3 exists.

In the second embodiment, post-combination three-dimensional point cloud data is obtained by combining the pieces of three-dimensional point cloud data which are obtained by the respective measurement sections, and the generation of the frequency data and the data reduction processing for the post-combination three-dimensional point cloud data based on the frequency data are executed for, as a target, the post-combination three-dimensional point cloud data.

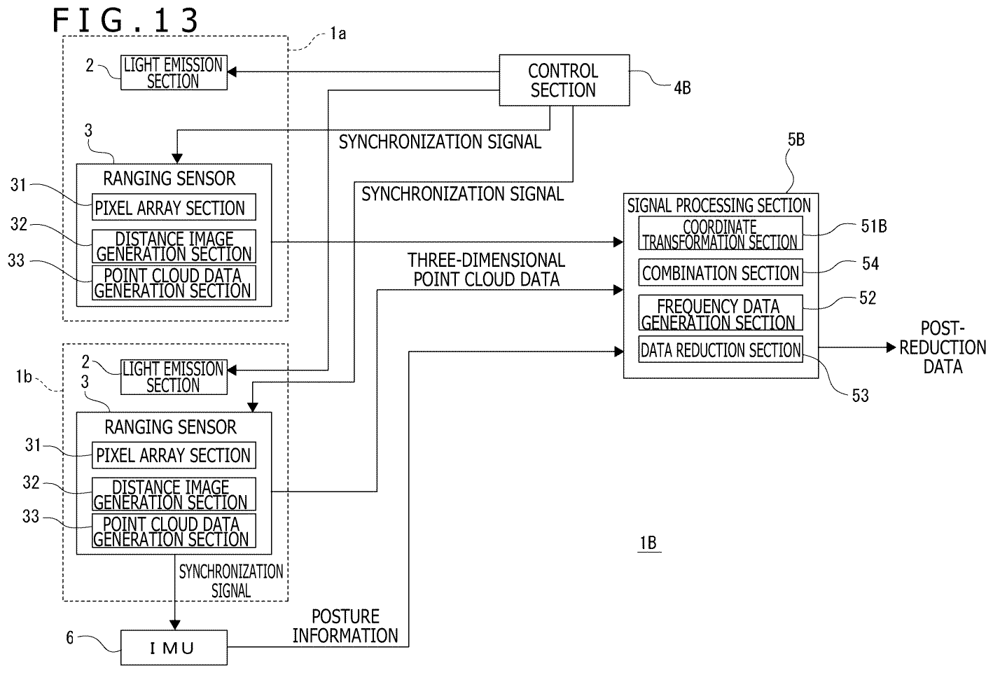

FIG. 13 is a block diagram for illustrating a configuration example of the signal processing device 1B as the second embodiment for implementing the data reduction method as the second embodiment as described above.

Note that, in a description given below, the same reference sign or the same step number is added to a portion similar to the portion already described, and a description thereof is omitted.

Moreover, in FIG. 13, description is given of a configuration example including, as the measurement section, two measurement sections which are measurement sections 1a and 1b, but the number of the measurement sections is only required to be larger than one.

The signal processing device 1B is different from the signal processing device 1 in that the two measurement sections 1a and 1b are provided as the measurement section including the light emission section 2 and the ranging sensor 3, that a control section 4B is provided in place of the control section 4, and that a signal processing section 5B is provided in place of the signal processing section 5.

The control section 4B executes the light emission control for both the light emission section 2 in the measurement section 1a and the light emission section 2 in the measurement section 1b. Moreover, the control section 4B outputs the synchronization signal to both the ranging sensor 3 in the measurement section 1a and the ranging sensor 3 in the measurement section 1b.

Note that, in the example illustrated in the diagram, as the synchronization signal (the frame synchronization signal for the ranging sensor 3) for the IMU 6, the synchronization signal from the ranging sensor 3 in the measurement section 1b is input, but as long as the frame cycles of the two ranging sensors 3 in the measurement section 1a and the measurement section 1b are synchronized with each other, the synchronization signal may be input from any one of the ranging sensors 3.

The signal processing section 5B is different from the signal processing section 5 in that a coordinate transformation section 51B is provided in place of the coordinate transformation section 51 and that a combination section 54 is added.

The coordinate transformation section 51B performs the coordinate transformation on the three-dimensional point cloud data input from each of the measurement sections 1a and 1b, through a method similar to that in the case of the first embodiment on the basis of the posture information input from the IMU 6.

The combination section 54 combines the pieces of three-dimensional point cloud data on which the coordinate transformation has been performed by the coordinate transformation section 51B. Note that, for the combination of the three-dimensional point cloud data, it is conceivable to employ only the point cloud data from either one of the measurement sections if there is an overlapping measurement portion between the measurement sections.

Moreover, the description here is given of the example in which the pieces of three-dimensional point cloud data of the respective measurement sections are combined after the coordinate transformation is performed, but it is also possible to execute the coordinate transformation for the three-dimensional point cloud data obtained after the combination.

The frequency data generation section 52 in this case generates the frequency data through a method similar to that in the case of the first embodiment on the basis of the post-combination three-dimensional point cloud data obtained by the combination section 54.

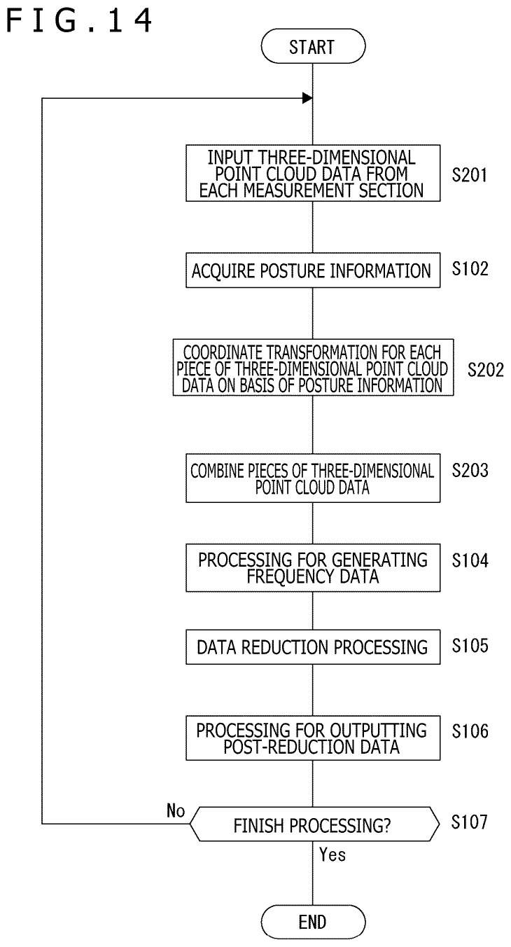

FIG. 14 is a flowchart for illustrating a processing procedure example of the processing executed by the signal processing section 5B.

The processing in this example is different from the processing illustrated in FIG. 9 in that input processing in Step S201 is executed in place of the input processing in Step S101, that coordinate transformation processing in Step S202 is executed in place of the coordinate transformation processing in Step S103, and that combination processing in Step S202 is added.

In Step S201, the signal processing section 5B inputs the three-dimensional point cloud data from each measurement section. That is, the signal processing section 5B inputs the three-dimensional point cloud data from the ranging sensors 3 of both of the measurement sections 1a and 1b.

Moreover, in Step S202, the signal processing section 5B executes the coordinate transformation processing for each piece of the three-dimensional point cloud data on the basis of the posture information acquired in Step S102. This is processing as the coordinate transformation section 51B described above.

After that, in Step S203 following Step S202, the signal processing section 5B executes processing for combining the pieces of three-dimensional point cloud data. This is processing as the combination section 54 described above.

The signal processing section 5B causes the processing to proceed to Step S104 in response to the execution of the combination processing in Step S203.

Processing in and after Step S104 is similar to that described in FIG. 9, and hence, a redundant description is avoided.

### 3. Third Embodiment

Now, the first and second embodiments described above are based on the example in which the processing for generating the frequency data and the data reduction processing based on the frequency data are executed in the same processor, but it is also possible to employ such a configuration that the processing for generating the frequency data and the frequency data are executed by processors different from each other.

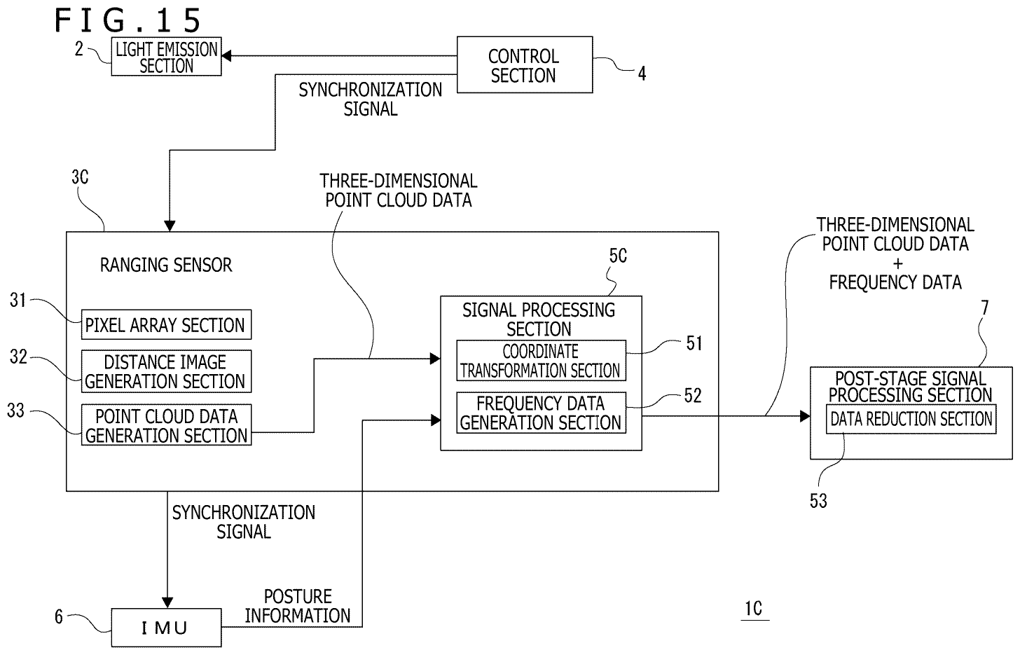

FIG. 15 is a block diagram for illustrating a configuration example of a signal processing device 1C as a third embodiment. Here, as the configuration example in which the processing for generating the frequency data and the data reduction processing based on the frequency data are executed by processors different from each other, there is exemplified a case in which a configuration based on the signal processing device 1A illustrated in FIG. 10 is employed.

The signal processing device 1C is different from the signal processing device 1A illustrated in FIG. 10 in that a ranging sensor 3C is provided in place of the ranging sensor 3A and that a post-stage signal processing section 7 is added.

The ranging sensor 3C is different from the ranging sensor 3A in that a signal processing section 5C is provided in place of the signal processing section 5. The signal processing section 5C is a section obtained by omitting the data reduction section 53 from the signal processing section 5.

The signal processing section 5C outputs, together with the frequency data generated by the frequency data generation section 52, the three-dimensional point cloud data on which the coordinate transformation has been performed by the coordinate transformation section 51, to the post-stage signal processing section 7 provided outside the ranging sensor 3C.

The post-stage signal processing section 7 includes a processor such as a microcomputer, an FPGA, or a DSP including a CPU, a ROM, a RAM, and the like, for example, and has the function as the data reduction section 53 as illustrated.

In the post-stage signal processing section 7, the data reduction section 53 receives inputs of the three-dimensional point cloud data and the frequency data output from the signal processing section 5C and executes the data reduction processing for the three-dimensional point cloud data on the basis of the frequency data through a method similar to the method described in the first embodiment.

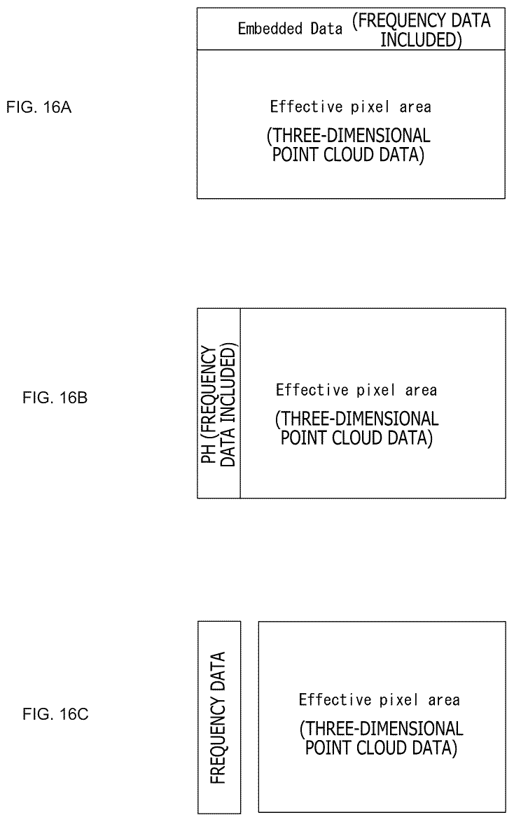

With reference to FIG. 16, a description is now given of data structure examples of the three-dimensional point cloud data and the frequency data transferred from the signal processing section 5C to the post-stage signal processing section 7.

A description here is given of data structure examples assuming the MIPI (Mobile Industry Processor Interface) standard as a transfer standard between the signal processing section 5C (the ranging sensor 3C) and the post-stage signal processing section 7.

For example, the example of FIG. 16A stores the frequency data in “Embedded Data” area provided for each frame of the transfer data. In this case, the three-dimensional point cloud data is stored in an actual data storage area as “Effective pixel area.”

Moreover, the example of FIG. 16B is an example which stores the frequency data for each line in the frame of the transfer data. For example, the frequency data is stored in an area of SOL (Start of Line) of the MIPI standard.

The example of FIG. 16C is an example of transferring the three-dimensional point cloud data and the frequency data independently of each other. In this case, for association between the three-dimensional point cloud data and the frequency data, it is conceivable to add the same frame number to each piece of data.

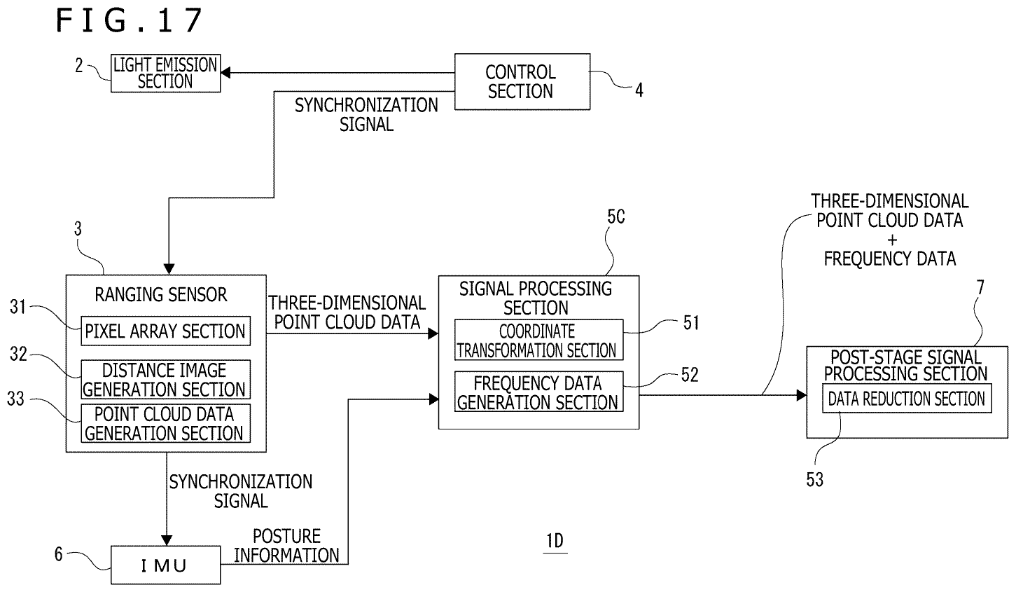

FIG. 17 is a block diagram for illustrating a configuration example of a signal processing device 1D as another example in the third embodiment. This signal processing device 1D is obtained by applying the configuration as the third embodiment to the signal processing device 1 illustrated in FIG. 1.

The signal processing device 1D is different from the signal processing device 1 in that the signal processing section 5C is provided in place of the signal processing section 5 and that the post-stage signal processing section 7 is added.

Note that, also in the third embodiment, it is possible to employ a configuration corresponding to the case in which a plurality of measurement sections is provided as in the second embodiment.

### 4. Modification Examples

The embodiments according to the present technology have been described, but the present technology is not limited to the specific examples described above and may employ various configurations as modification examples.

For example, in the description given above, there is exemplified such a configuration that the processing for generating the frequency data and the data reduction processing for the three-dimensional point cloud data based on the frequency data are executed in the signal processing device, but it is also conceivable to execute the data reduction processing for the three-dimensional point cloud data based on the frequency data in a device provided outside the signal processing device.

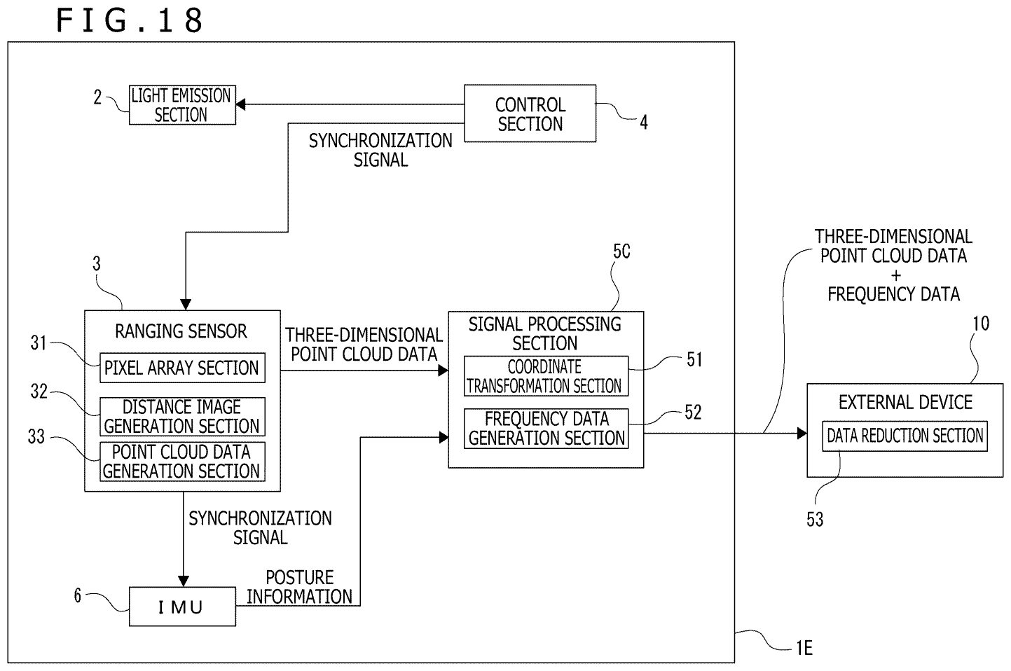

A specific configuration example is illustrated in FIG. 18.

In FIG. 18, a signal processing device 1E is different from the signal processing device 1 in that the signal processing section 5C is provided in place of the signal processing section 5.

The signal processing device 1E outputs the three-dimensional point cloud data on which the coordinate transformation has been performed by the coordinate transformation section 51, together with the frequency data generated by the frequency data generation section 52, to an external device 10.

The external device 10 includes a processor such as a microcomputer, an FPGA, or a DSP including a CPU, a ROM, a RAM, and the like, for example, and has the function as the data reduction section 53 as illustrated. As this external device 10, there is assumed a device which executes the travel control for the moving body M on the basis of the three-dimensional point cloud data.

Specifically, the external device 10 has a function of executing the travel control for the moving body M on the basis of the post-reduction data obtained by the data reduction section 53 executing the data reduction processing on the basis of the frequency data.

Here, in a case in which there is assumed a control system in which the signal processing device 1E executes the processing for generating the frequency data as described above and the external device 10 executes the data reduction processing for the three-dimensional point cloud data based on the frequency data, the signal processing device 1E transfers, to the external device 10, the three-dimensional point cloud data and the frequency data. Also for this transfer data, as in the example described with reference to FIG. 16, it is conceivable to employ such a method as storing the frequency data in an additional data area provided for each predetermined data unit such as a frame or a line in the transfer data. As another example, there is also conceivable a method which transfers the three-dimensional point cloud data and the frequency data independently of each other.

Here, the data including the three-dimensional point cloud data and the frequency data transferred by the signal processing device 1E to the external device 10 can be referred to also as “control data” since it is used for the control based on the three-dimensional point cloud data.

Here, as the moving body M, the moving body of the ground contact type is exemplified in the description given above, but, as the moving body M, there can be conceivable, for example, a flying body such as a drone or an airplane and a moving body other than that of the ground contact type.

Moreover, regarding this point, the control based on the three-dimensional point cloud data in the present technology is not limited to the travel control for the moving body M.

In the present technology, specific control contents of the control based on the dimensional point cloud data are not limited to any particular contents.

Moreover, for the three-dimensional measurement, the case in which the ranging through the ToF method is executed is exemplified in the description given above, but, in the present technology, the method for the three-dimensional measurement is not limited to the ToF method. For example, the three-dimensional measurement can be executed through use of the LiDAR (Light Detection And Ranging) method, a stereo camera, the monocular SLAM (Simultaneous Localization and Mapping), the stereo SLAM, and the like other than the ToF type.

As another example, as the three-dimensional measurement, it is also conceivable to employ an ultrasonic ranging method, a method through use of an electromagnetic wave radar, or the like.

### 5. Summary of Embodiments

As described above, the signal processing device (the signal processing device 1, 1A, 1B, or 1D) as the embodiment includes the frequency data generation section (the frequency data generation section 52) that generates the frequency data that is the data indicating the frequency of the point in at least the depth direction, on the basis of the three-dimensional point cloud data acquired through the three-dimensional measurement of the target space, and the data reduction section (the data reduction section 53) that executes the data reduction processing for the three-dimensional point cloud data on the basis of the frequency data generated by the frequency data generation section.

With the configuration described above, for the three-dimensional point cloud data, it is possible to efficiently extract only point cloud data in a region in which the point cloud densely exists in the depth direction, in other words, point cloud data at a depth position at which an object is estimated to exist.

Thus, in a case in which there is executed, as the control based on the sensing data in the target space, the control based on the three-dimensional point cloud data regarding the target space, it is possible to efficiently reduce the three-dimensional point cloud data other than the point cloud data existing at the depth position at which the object is estimated to exist, and hence, it is possible to simultaneously achieve an increase in accuracy of the control and a reduction in processing load.

Moreover, it is possible to reduce the amount of data transferred to the post-stage processor which executes the control, and hence, it is possible to achieve a reduction in data transfer time, a reduction in frequency band of a communication path, and an increase in processing speed of the post-stage processing.

Moreover, in the signal processing device as the embodiment, the frequency data generation section generates, as the frequency data, the data indicating the frequencies of the point in the two directions, i.e., the depth direction and the orthogonal direction of the depth direction.

As a result, as the frequency data, there is obtained data which indicates a region in which the points are concentrated on the two-dimensional plane (Z-X plane or Z-Y plane) defined by the axis (Z axis) in the depth direction and the axis (X axis or Y axis) in the orthogonal direction thereof.

Thus, as a result of the data reduction processing for the three-dimensional point cloud data based on such frequency data, it is possible to efficiently extract the point cloud data regarding only the region in which the object is estimated to exist in the orthogonal direction of the depth direction.

Further, in the signal processing device as the embodiment, the frequency data generation section generates, as the frequency data, the data indicating the frequencies of the point in the two directions, i.e., the depth direction and the lateral direction.

As a result, as the frequency data, there is obtained the data which indicates a region in which the points are concentrated on the two-dimensional plane (Z-X plane) defined by the axis (Z axis) in the depth direction and the axis (X axis) in the lateral direction.

Thus, as a result of the data reduction processing for the three-dimensional point cloud data based on such frequency data, it is possible to efficiently extract the point cloud data regarding only the region in which the object is estimated to exist in the lateral direction.

Further, the signal processing device as the embodiment includes the coordinate transformation section (the coordinate transformation section 51 or 51B) that executes the coordinate transformation for the three-dimensional point cloud data, and the frequency data generation section generates the frequency data on the basis of the three-dimensional point cloud data obtained after the coordinate transformation by the coordinate transformation section.

As a result, even in a case in which the posture of the measurement section which executes the three-dimensional measurement is different from the ideal posture, it is possible to execute the coordinate transformation such that the three-dimensional data in the case of measurement executed at the ideal posture can be acquired.

Thus, it is possible to increase an installation degree of freedom of the measurement section.

Moreover, the signal processing device (the signal processing device 1B) as the embodiment includes the combination section (the combination section 54) that combines a plurality of pieces of the three-dimensional point cloud data acquired through three-dimensional measurement of the target space from different viewpoints, and the frequency data generation section generates the frequency data on the basis of the three-dimensional point cloud data obtained after the combination by the combination section.

As a result, in correspondence to the case in which a plurality of measurement sections is provided to increase the measurement range, it is possible to efficiently reduce the three-dimensional point cloud data, and hence, it is possible to simultaneously achieve an increase in accuracy of the control and a reduction in processing load.

Moreover, in the case in which a plurality of measurement sections is provided to increase the measurement range, the number of three-dimensional point clouds involved increases, and hence, it is particularly preferred to use the present technology to efficiently reduce the three-dimensional point cloud data.

Further, in the signal processing device (the signal processing device 1, 1A, 1B, or 1D) as the embodiment, the data reduction section executes the processing for extracting and outputting the point cloud data that is included in the three-dimensional point cloud data and that has the frequency equal to or higher than the threshold value in the frequency data.

As a result, as the post-reduction data, it is possible to efficiently extract and output only the point cloud data existing in the region in which the object is estimated to exist in the depth direction.

Further, in the signal processing device as the embodiment, the frequency data generation section generates, as the frequency data, the data indicating the frequencies of the point in the two directions, i.e., the depth direction and the orthogonal direction of the depth direction, and the data reduction section executes the processing for extracting and outputting the point cloud data having the frequency equal to or higher than the threshold value in the frequency data indicating the frequencies of the point in the two directions generated by the frequency data generation section.

As a result, as the post-reduction data, it is possible to efficiently extract and output the point cloud data existing only in the region in which the object is estimated to exist in the orthogonal direction of the depth direction. It is possible to achieve more data amount reduction in post-reduction data than that in the case in which only the point cloud data existing in the region in which the object is estimated to exist in the depth direction is extracted and output.

Moreover, in the signal processing device as the embodiment, the frequency data generation section generates, as the frequency data, the data indicating the frequencies of the point in the two directions, i.e., the depth direction and the orthogonal direction of the depth direction, and the data reduction section extracts the point cloud data that is included in the three-dimensional point cloud data and that has a frequency equal to or higher than the threshold value in the frequency data, and outputs the two-dimensional data obtained by projecting the extracted point cloud data on the two-dimensional plane defined by the axis in the depth direction and the axis in the orthogonal direction.

As a result, as the post-reduction data, it is possible to output data that has been reduced to only the two types of data, i.e., the data indicating the region in which the object is estimated to exist in the orthogonal direction of the depth direction and the data indicating the position of the object in the depth direction. It is possible to achieve more data amount reduction in post-reduction data than that in the case in which the point cloud data only in the region in which the object is estimated to exist in the orthogonal direction of the depth direction is extracted and output.

Moreover, in the signal processing device as the embodiment, the frequency data generation section generates, as the frequency data, the data indicating the frequencies of the point in the two directions, i.e., the depth direction and the orthogonal direction of the depth direction, and the data reduction section extracts the point cloud data that is included in the three-dimensional point cloud data and that has a frequency equal to or higher than the threshold value in the frequency data, and extracts and outputs only the coordinate information in the depth direction of the extracted point cloud data.

As a result, as the post-reduction data, it is possible to output the data that has been reduced only to the data indicating the position of the object in the depth direction.

The signal processing method according to the embodiment is a signal processing method including, by the signal processing device, generating the frequency data that is the data indicating the frequency of the point in at least the depth direction, on the basis of the three-dimensional point cloud data acquired through the three-dimensional measurement of the target space, and executing the data reduction processing for the three-dimensional point cloud data on the basis of the frequency data.

Also with this signal processing method, there can be obtained workings and effects similar to those of the signal processing devices as the embodiments described above.

Moreover, the data production method as the embodiment is the data production method for producing the control data to be used in the control system (the signal processing device 1E and the external device 10) that executes the control based on the three-dimensional point cloud data acquired through the three-dimensional measurement of the target space, in which the control data includes the three-dimensional point cloud data and the frequency data that is generated on the basis of the three-dimensional point cloud data and that indicates the frequency of the point in at least the depth direction, and the control data used when the control system executes the data reduction processing for the three-dimensional point cloud data on the basis of the frequency data is produced.

With the control data produced by such a data production method, it is possible to efficiently reduce the three-dimensional point cloud data other than the point cloud data existing at the depth position at which an object is estimated to exist, in a case in which the control based on the three-dimensional point cloud data regarding the target space is executed.

Thus, it is possible to simultaneously achieve an increase in accuracy of the control and a reduction in processing load. Note that the effects described in the present specification are mere examples and are not limitative, and there may exist other effects.

### 6. Present Technology

The present technology can also adopt the following configurations.

(1)

A signal processing device including:
a frequency data generation section that generates frequency data that is data indicating a frequency of a point in at least a depth direction, on the basis of three-dimensional point cloud data acquired through three-dimensional measurement of a target space; and
a data reduction section that executes data reduction processing for the three-dimensional point cloud data on the basis of the frequency data generated by the frequency data generation section.
   (2)

The signal processing device according to (1) above, in which the frequency data generation section generates, as the frequency data, data indicating frequencies of the point in two directions which are the depth direction and an orthogonal direction of the depth direction.

(3)

The signal processing device according to (2) above, in which the frequency data generation section generates, as the frequency data, data indicating frequencies of the point in two directions which are the depth direction and a lateral direction.

(4)

The signal processing device according to any of (1) to (3) above, including:
a coordinate transformation section that executes coordinate transformation for the three-dimensional point cloud data,
in which the frequency data generation section generates the frequency data on the basis of the three-dimensional point cloud data obtained after the coordinate transformation by the coordinate transformation section.
   (5)

The signal processing device according to any of (1) to (4) above, including:
a combination section that combines a plurality of pieces of three-dimensional point cloud data acquired through three-dimensional measurement of the target space from different viewpoints,
in which the frequency data generation section generates the frequency data on the basis of the three-dimensional point cloud data obtained after the combination by the combination section.
   (6)

The signal processing device according to any of (1) to (5) above, in which the data reduction section executes processing for extracting and outputting point cloud data that is included in the three-dimensional point cloud data and that has a frequency equal to or higher than a threshold value in the frequency data.

(7)

The signal processing device according to (6) above,
in which the frequency data generation section generates, as the frequency data, data indicating frequencies of the point in two directions which are the depth direction and an orthogonal direction of the depth direction, and
the data reduction section executes processing for extracting and outputting point cloud data having a frequency equal to or higher than a threshold value in the frequency data that indicates the frequencies of the point in the two directions and that is generated by the frequency data generation section.
   (8)

The signal processing device according to any of (1) to (5) above,
in which the frequency data generation section generates, as the frequency data, data indicating frequencies of the point in two directions which are the depth direction and an orthogonal direction of the depth direction, and
the data reduction section extracts point cloud data that is included in the three-dimensional point cloud data and that has a frequency equal to or higher than a threshold value in the frequency data, and outputs two-dimensional data obtained by projecting the extracted point cloud data on a two-dimensional plane defined by an axis in the depth direction and an axis in the orthogonal direction.
   (9)

The signal processing device according to any of (1) to (5) above,
in which the frequency data generation section generates, as the frequency data, data indicating frequencies of the point in two directions which are the depth direction and an orthogonal direction of the depth direction, and
the data reduction section extracts point cloud data that is included in the three-dimensional point cloud data and that has a frequency equal to or higher than a threshold value in the frequency data, and extracts and outputs only coordinate information in the depth direction of the extracted point cloud data.
   (10)

A signal processing method including:
by a signal processing device,
generating frequency data that is data indicating a frequency of a point in at least a depth direction, on the basis of three-dimensional point cloud data acquired through three-dimensional measurement of a target space; and
executing data reduction processing for the three-dimensional point cloud data on the basis of the frequency data.
   (11)

A data production method for producing control data to be used in a control system that executes control based on three-dimensional point cloud data acquired through three-dimensional measurement of a target space,
in which the control data includes the three-dimensional point cloud data and frequency data that is generated on the basis of the three-dimensional point cloud data and that indicates a frequency of a point in at least a depth direction, and
the control data used when the control system executes data reduction processing for the three-dimensional point cloud data on the basis of the frequency data is produced.

### REFERENCE SIGNS LIST

1, 1A, 1B, 1C, 1D, 1E: Signal processing device
M: Moving body
Ob, Ob1, Ob2, Ob3: Object
1a, 1b, 1c: Measurement section
2: Light emission section
3, 3A, 3C: Ranging sensor
31: Pixel array section
32: Distance image generation section
33: Point cloud data generation section
4, 4B: Control section
5, 5B, 5C: Signal processing section
51, 51B: Coordinate transformation section
52: Frequency data generation section
53: Data reduction section
54: Combination section
6: IMU
S: Cell
L: Line
7: Post-stage signal processing section
10: External device

1. A signal processing device comprising:
a frequency data generation section that generates frequency data that is data indicating a frequency of a point in at least a depth direction, on a basis of three-dimensional point cloud data acquired through three-dimensional measurement of a target space; and
a data reduction section that executes data reduction processing for the three-dimensional point cloud data on a basis of the frequency data generated by the frequency data generation section.

2. The signal processing device according to claim 1, wherein the frequency data generation section generates, as the frequency data, data indicating frequencies of the point in two directions which are the depth direction and an orthogonal direction of the depth direction.

3. The signal processing device according to claim 2, wherein the frequency data generation section generates, as the frequency data, data indicating frequencies of the point in two directions which are the depth direction and a lateral direction.

4. The signal processing device according to claim 1, comprising:
a coordinate transformation section that executes coordinate transformation for the three-dimensional point cloud data,
wherein the frequency data generation section generates the frequency data on a basis of the three-dimensional point cloud data obtained after the coordinate transformation by the coordinate transformation section.

5. The signal processing device according to claim 1, comprising:
a combination section that combines a plurality of pieces of three-dimensional point cloud data acquired through three-dimensional measurement of the target space from different viewpoints,
wherein the frequency data generation section generates the frequency data on a basis of the three-dimensional point cloud data obtained after the combination by the combination section.

6. The signal processing device according to claim 1, wherein the data reduction section executes processing for extracting and outputting point cloud data that is included in the three-dimensional point cloud data and that has a frequency equal to or higher than a threshold value in the frequency data.

7. The signal processing device according to claim 6,
wherein the frequency data generation section generates, as the frequency data, data indicating frequencies of the point in two directions which are the depth direction and an orthogonal direction of the depth direction, and
the data reduction section executes processing for extracting and outputting point cloud data having a frequency equal to or higher than a threshold value in the frequency data that indicates the frequencies of the point in the two directions and that is generated by the frequency data generation section.

8. The signal processing device according to claim 1,
wherein the frequency data generation section generates, as the frequency data, data indicating frequencies of the point in two directions which are the depth direction and an orthogonal direction of the depth direction, and
the data reduction section extracts point cloud data that is included in the three-dimensional point cloud data and that has a frequency equal to or higher than a threshold value in the frequency data, and outputs two-dimensional data obtained by projecting the extracted point cloud data on a two-dimensional plane defined by an axis in the depth direction and an axis in the orthogonal direction.

9. The signal processing device according to claim 1,
wherein the frequency data generation section generates, as the frequency data, data indicating frequencies of the point in two directions which are the depth direction and an orthogonal direction of the depth direction, and
the data reduction section extracts point cloud data that is included in the three-dimensional point cloud data and that has a frequency equal to or higher than a threshold value in the frequency data, and extracts and outputs only coordinate information in the depth direction of the extracted point cloud data.

10. A signal processing method comprising:
by a signal processing device,
generating frequency data that is data indicating a frequency of a point in at least a depth direction, on a basis of three-dimensional point cloud data acquired through three-dimensional measurement of a target space; and
executing data reduction processing for the three-dimensional point cloud data on a basis of the frequency data.

11. A data production method for producing control data to be used in a control system that executes control based on three-dimensional point cloud data acquired through three-dimensional measurement of a target space,
wherein the control data includes the three-dimensional point cloud data and frequency data that is generated on a basis of the three-dimensional point cloud data and that indicates a frequency of a point in at least a depth direction, and
the control data used when the control system executes data reduction processing for the three-dimensional point cloud data on a basis of the frequency data is produced.
